(19) United States
(12) Patent Application Publication
(10) Pub. No.: US 2012/0125040 A1
(43) Pub. Date: May 24, 2012

(54) OIL SEPARATOR

(75) Inventor: Takaaki MATSUI, Tokyo (JP)

(73) Assignee: SUMITOMO HEAVY INDUSTRIES, LTD., Tokyo (JP)

(21) Appl. No.: 13/297,589

(22) Filed: Nov. 16, 2011

(30) Foreign Application Priority Data
Nov. 18, 2010 (JP) 2010-258139

(51) Int. Cl. F25B 43/02; B01D 46/00

(52) U.S. Cl. 62/470; 55/482

(57) ABSTRACT

An oil separator separating oil contained in coolant gas includes an inlet part provided on the upstream side in a passage through which the coolant gas flows, and including a gas inlet port to introduce the coolant gas; an outlet part provided on the downstream side in the passage and including a gas outlet port to lead out the coolant gas and an oil discharge port to discharge the separated oil; a first filtration part provided between the inlet part and the outlet part and configured to filter out the oil from the coolant gas; a second filtration part provided on the downstream side of the first filtration part with a gap between the first and second filtration parts, and configured to filter out the oil from the coolant gas; and an oil separating part including a perforated plate provided on the downstream-side end face of the first filtration part.

### CROSS-REFERENCE TO RELATED APPLICATION

The present application is based upon and claims the benefit of priority of Japanese Patent Application No. 2010-258139, filed on Nov. 18, 2010, the entire contents of which are incorporated herein by reference.

### BACKGROUND OF THE INVENTION

1. Field of the Invention

The present invention relates to an oil separator provided between a compressor and a refrigerator to separate oil contained in coolant gas.

2. Description of the Related Art

While there are various kinds of regenerative refrigerators such as Gifford-McMahon refrigerators (hereinafter referred to as “GM refrigerators), Joule-Thomson/GM refrigerators, Claude cycle refrigerators, and Stirling refrigerators, in general, GM refrigerators are widely used. The GM refrigerator is connected to a compressor. The GM refrigerator attains cryogenic temperatures by generating cold by adiabatically expanding high-pressure coolant gas (for which helium gas is commonly used) fed from the compressor from high pressure to low pressure in the GM refrigerator and storing the generated cold in a regenerator material provided in a regenerator

The compressor increases the pressure of the low-pressure coolant gas returned from the GM refrigerator (return gas) in its body, and refeeds the coolant gas to the GM refrigerator as supply gas. Thus, the return gas returned from the GM refrigerator is again compressed in the body of the compressor, and the compressed coolant gas (supply gas) is cooled in a coolant gas heat exchanging part.

The cooled coolant gas is sent to an oil separator, where oil is separated from the coolant gas. Japanese National Publication of International Patent Application No. 2006-501985 illustrates such an oil separator. The coolant gas from which oil has been separated is sent to an adsorber, and is thereafter fed to the GM refrigerator as supply gas.

Japanese National Publication of International Patent Application No. 2006-501985 discloses a horizontal oil separator. In the case illustrated in Japanese National Publication of International Patent Application No. 2006-501985, an oil separator includes a vessel, a conduit, a vane mist eliminator, and a mesh mist eliminator (a filtering part). The vessel has a first head at one end, a second head at the other end, a cylindrical shell extending between the first head and the second head, an inlet port open at a first position in the vessel, and a discharge port open at a second position. The conduit is for directing fluid formed of a mixture of oil and compressed gas to the inlet port of the vessel. Further, in the case illustrated in Japanese National Publication of International Patent Application No. 2006-501985, the mesh mist eliminator is used as a principal part of the filtering part that filters out oil.

### SUMMARY OF THE INVENTION

According to an aspect of the present invention, an oil separator configured to separate oil contained in coolant gas includes an inlet part provided on an upstream side in a passage through which the coolant gas flows from a compressor compressing the coolant gas toward a refrigerator generating cold by expanding the coolant gas, the inlet part including a gas inlet port configured to introduce the coolant gas; an outlet part provided on a downstream side in the passage, the outlet part including a gas outlet port configured to lead out the coolant gas and an oil discharge port configured to discharge the separated oil; a first filtration part provided between the inlet part and the outlet part and configured to filter out the oil from the coolant gas; a second filtration part provided on a downstream side of the first filtration part with a gap between the first filtration part and the second filtration part, and configured to filter out the oil from the coolant gas; and an oil separating part including a perforated plate provided on a downstream-side end face of the first filtration part.

The object and advantages of the invention will be realized and attained by means of the elements and combinations particularly pointed out in the claims.

It is to be understood that both the foregoing general description and the following detailed description are exemplary and explanatory and not restrictive of the invention as claimed.

### BRIEF DESCRIPTION OF THE DRAWINGS

Other objects, features and advantages of the present invention will become more apparent from the following detailed description when read in conjunction with the accompanying drawings, in which:

FIG. 1 is a diagram illustrating a compressor for a regenerative refrigerator according to a first embodiment of the present invention;

FIG. 2 is a cross-sectional view of an oil separator according to the first embodiment of the present invention, illustrating a configuration thereof;

FIG. 3 is a cross-sectional view of the oil separator according to the first embodiment of the present invention, illustrating another configuration thereof;

FIG. 4 is a cross-sectional view of an oil separator according to a comparative example, illustrating a configuration thereof;

FIG. 5 is a schematic diagram illustrating how coolant gas containing oil passes through a filter member of the oil separator according to the comparative example;

FIG. 6 is a schematic diagram illustrating how coolant gas containing oil passes through first and second filter members of the oil separator according to the first embodiment of the present invention;

FIG. 7A is a graph illustrating the relationship between air gap size and oil outlet velocity and FIG. 7B is a graph illustrating the relationship between a variable that is the ratio of the air gap size to the flow velocity of coolant gas and the oil outlet velocity according to the first embodiment of the present invention;

FIG. 8A is a cross-sectional view of an oil separator according to a first variation of the first embodiment of the present invention, illustrating a configuration thereof, and FIG. 8B is a diagram for illustrating an angle of inclination θ according to the first variation;

FIG. 9 is a cross-sectional view of an oil separator according to a second variation of the first embodiment of the present invention, illustrating a configuration thereof; and

FIG. 10 is a cross-sectional view of an oil separator according to a second embodiment of the present invention, illustrating a configuration thereof.

### DETAILED DESCRIPTION OF THE PREFERRED EMBODIMENTS

As described above, the oil separator is provided between a refrigerator and a compressor. Such an oil separator, however, has the following problems.

The filtering part provided in the oil separator is filled tightly with a filter material. This prevents liquefied oil from flowing downward, so that the coolant gas and the oil are ejected in a mixed state from the entire downstream-side end face of the filtering part. Then, the oil ejected from the entire downstream-side end face of the filtering part enters a coolant gas passage on the downstream side (refrigerator side). As a result, there is the problem of the entrance of oil into pipes, a tank, and other various kinds of equipment on the downstream side (refrigerator side), which are supposed to be kept free of entrance of oil.

In the example disclosed in Japanese National Publication of International Patent Application No. 2006-501985, a vane mist eliminator is also provided on the upstream side in the oil separator. However, the filtering part that filters out oil is substantially the mesh mist eliminator. In the mesh mist eliminator, which is filled tightly with a filter material, liquefied oil is prevented from flowing downward. Therefore, there is a problem in that the coolant gas and the oil are ejected in a mixed state from the entire downstream-side end face of the mesh mist eliminator.

According to an aspect of the present invention, an oil separator configured to separate oil from coolant gas ejected from a compressor for a refrigerator is provided that makes it possible to prevent oil from being ejected from the entire downstream-side end face of a filtering part configured to filter out oil and to separate the filtered-out oil from the coolant gas with efficiency.

Next, a description is given, with reference to the accompanying drawings, of embodiments of the present invention.

### First Embodiment

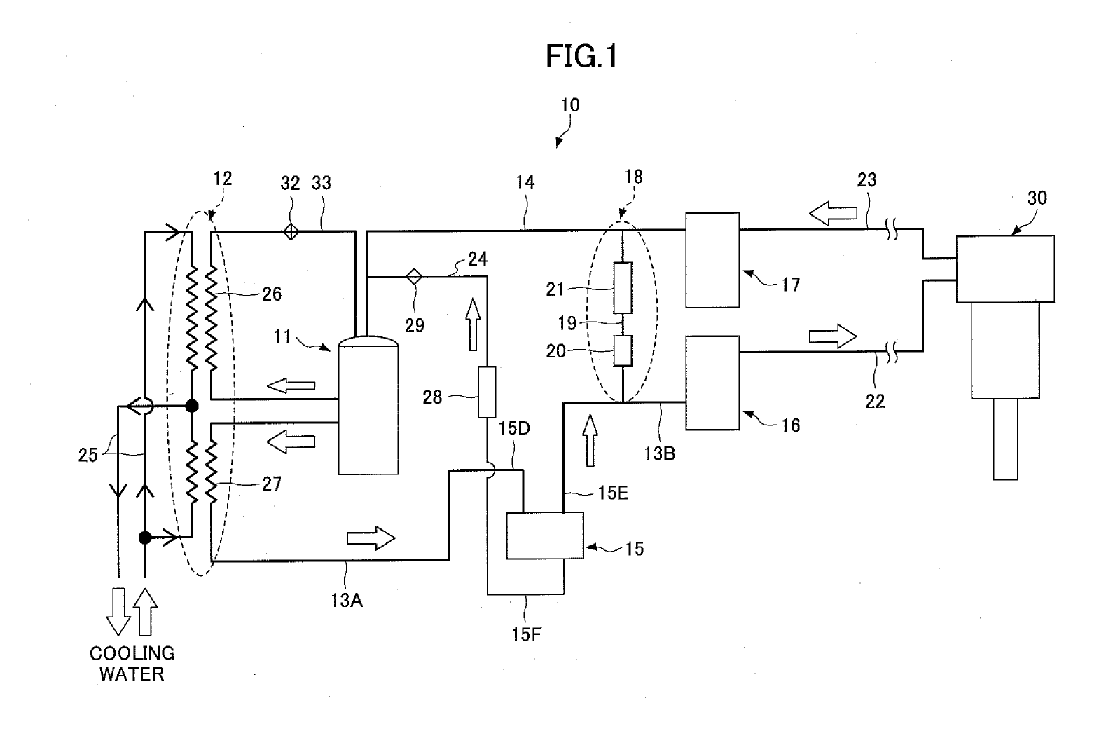

A description is given, with reference to FIG. 1, of a compressor for a regenerative refrigerator which compressor includes an oil separator according to a first embodiment of the present invention. In this embodiment, a description is given of the case where a GM refrigerator is used as a regenerative refrigerator.

FIG. 1 is a diagram illustrating a compressor for a regenerative refrigerator (hereinafter referred to as “compressor”) 10 according to this embodiment.

The compressor 10 includes a compressor body 11, a heat exchanger 12, high-pressure-side pipes 13A and 13B, a low-pressure-side pipe 14, an oil separator 15, an adsorber 16, a storage tank 17, and a bypass mechanism 18. The compressor 10 is connected to a GM refrigerator 30 via a supply tube 22 and a return tube 23. The compressor 10 increases the pressure of low-pressure coolant gas returned from the GM refrigerator 30 via the return pipe 23 (return gas) in the compressor body 11, and refeeds the coolant gas whose pressure has been increased to the GM refrigerator 30 via the supply tube 22.

The return gas returned from the GM refrigerator 30 first flows into the storage tank 17 via the return pipe 23. The storage tank 17 is for removing pulsations contained in the return gas. The storage tank 17 has a relatively large capacity, so that it is possible to remove pulsations from the return gas by introducing the return gas into the storage tank 17.

The return gas having pulsations removed in the storage tank 17 is led out to the low-pressure-side pipe 14. The low-pressure-side tube 14 is connected to the compressor body 11, so that the return gas having pulsations removed in the storage tank 17 is fed to the compressor body 11.

The compressor body 11, which is, for example, a scroll or a rotary pump, is for compressing the return gas into high-pressure coolant gas (supply gas). The compressor body 11 sends out the supply gas of increased pressure to the high-pressure-side pipe 13A. The supply gas is compressed (pressurized) in the compressor body 11 to be sent out to the high-pressure-side pipe 13A with a slight amount of oil in the compressor body 11 being mixed into the supply gas.

The high-pressure-side pipes 13A and 13B correspond to a coolant gas passage through which the coolant gas flows from the compressor 10 toward the GM refrigerator 30.

The compressor body 11 performs cooling using oil. Therefore, an oil cooling pipe 33 for circulating oil is connected to an oil heat exchanging part 26 of the heat exchanger 12. Further, an orifice 32 is provided in the oil cooling pipe 33 to control the flow rate of oil flowing inside the oil cooling pipe 33.

The heat exchanger 12 is so configured as to cause cooling water to circulate through a cooling water pipe 25. The heat exchanger 12 includes the oil heat exchanging part 26 and a coolant gas heat exchanging part 27. The oil heat exchanging part 26 is configured to cool oil flowing through the oil cooling pipe 33. The coolant gas heat exchanging part 27 is configured to cool supply gas. The oil flowing through the oil cooling pipe 33 is subjected to heat exchange (heat transfer) in the oil heat exchanging part 26 and is cooled. The supply gas flowing through the high-pressure-side pipe 13A is subjected to heat exchange in the coolant gas heat exchanging part 27 and is cooled.

The supply gas compressed in the compressor body 11 and cooled in the coolant gas heat exchanging part 27 is fed to the oil separator 15 via the high-pressure-side pipe 13A. In the oil separator 15, the oil contained in the supply gas is separated from the coolant, and impurities and dust included in the oil are also removed. The details of a configuration of the oil separator 15 are discussed below.

The supply gas having oil removed in the oil separator 15 is sent to the adsorber 16 via the high-pressure-side pipe 13B. The adsorber 16 is for removing a vaporized oil component contained in the supply gas in particular. After removal of a vaporized oil component in the adsorber 16, the supply gas is led out to the supply tube 22 to be fed to the GM refrigerator 30.

The bypass mechanism 18 includes a bypass tube 19, a high-pressure-side pressure detector 20, and a bypass valve 21. The bypass pipe 19 connects the high pressure side of the compressor 10, where the supply gas flows, and the low pressure side of the compressor 10, where the return gas flows. The high-pressure-side pressure detector 20 is configured to detect the pressure of the supply gas inside the high-pressure-side pipe 13B. The bypass valve 21 is an electrically operated valve device configured to open and close the bypass pipe 19. Further, the bypass valve 21, which is normally closed, is driven and controlled by the high-pressure-side pressure detector 20.

For example, the bypass valve 21 is configured to be driven by the high-pressure-side pressure detector 20 to be open in response to the high-pressure-side pressure detector 20 detecting that the pressure of the supply gas between the oil separator 15 and the adsorber 16 (that is, the pressure inside the high-pressure-side pipe 13B) is greater than or equal to a predetermined pressure. This prevents supply gas of a pressure greater than or equal to the predetermined pressure from being fed to the GM refrigerator.

An oil return pipe 24 is connected to the oil separator 15 on the high pressure side and to the low-pressure-side pipe 14 on the low pressure side. A filter 28 configured to remove dust contained in the oil separated in the oil separator 15 and an orifice 29 configured to control the amount of oil return are provided in the oil return pipe 24.

Next, a description is given, with reference to FIG. 1 through FIG. 3, of the oil separator 15 according to this embodiment. The oil separator 15 is an application of an oil separator according to the present invention to a horizontal oil separator.

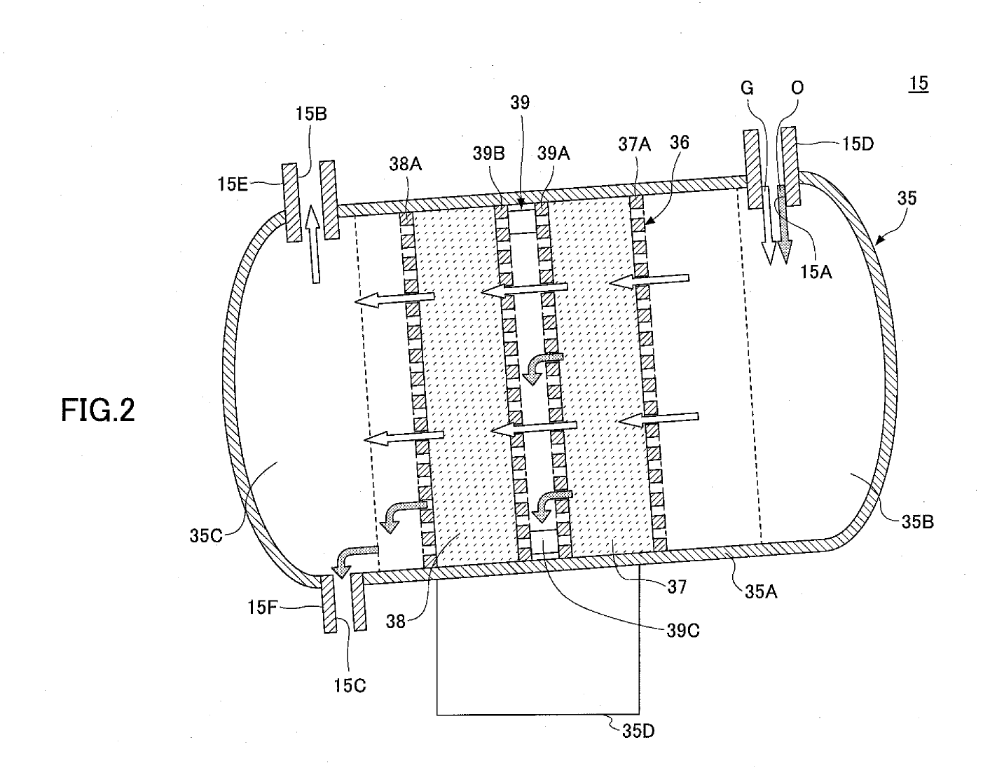

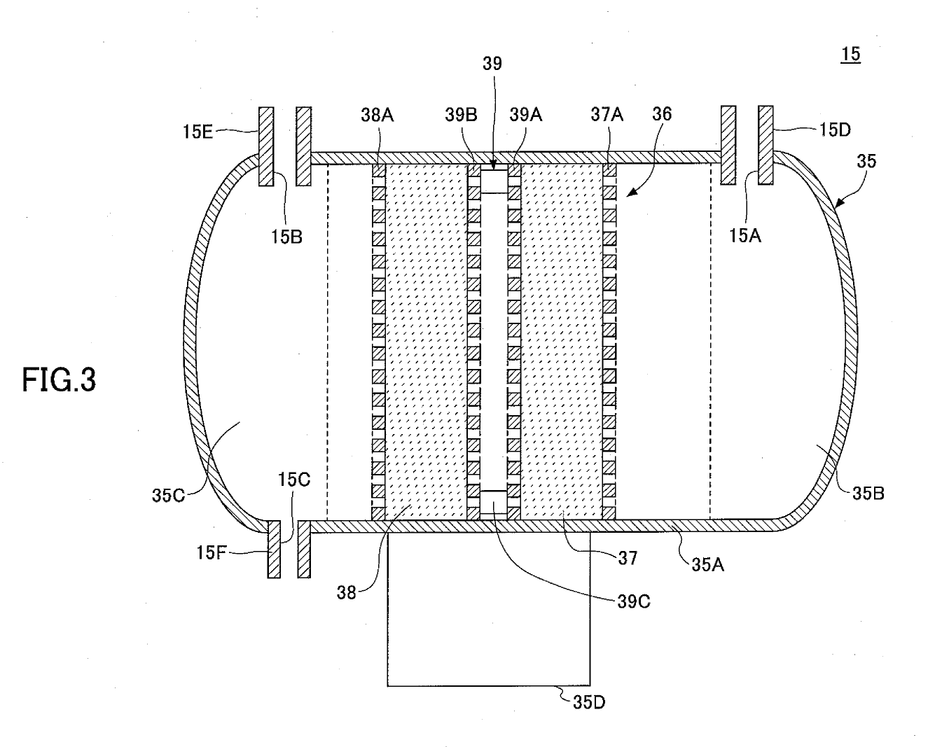

FIG. 2 is a cross-sectional view of the oil separator 15 according to this embodiment, illustrating a configuration of the oil separator 15. FIG. 3 is a cross-sectional view of the oil separator 15 according to this embodiment, illustrating another configuration of the oil separator 15.

In FIG. 2, a flow of coolant gas is indicated by arrows G, and a flow of oil is indicated by arrows O.

The oil separator 15 includes a shell 35 and a filter element 36.

The shell 35 includes a cylindrical part 35A, an inlet part 35B, an outlet part 35C, and a placement table 35D. The cylindrical part 35A has a hollow, cylindrical shape elongated substantially horizontally. The inlet part 35B is provided hermetically sealed on the cylindrical part 35A on its upstream side in the gas (oil) flowing direction. The outlet part 35C is provided hermetically sealed on the cylindrical part 35A on its downstream side in the gas (oil) flowing direction.

The inlet part 35B is provided with a high-pressure gas inlet port 15A for introducing coolant gas, which is high-pressure gas. A high-pressure gas introduction pipe 15D is connected to the high-pressure gas inlet port 15A. The high-pressure gas introduction pipe 15D is connected to the high-pressure-side pipe 13A illustrated in FIG. 1. The high-pressure gas inlet port 15A may correspond to a gas inlet port according to an aspect of the present invention.

The outlet part 35C is provided with a high-pressure gas outlet port 15B for leading out the coolant gas, which is high-pressure gas. A high-pressure gas lead-out pipe 15E is connected to the high-pressure gas outlet port 15B. The high-pressure gas lead-out pipe 15E is connected to the high-pressure-side pipe 13B illustrated in FIG. 1. The high-pressure gas outlet port 15B may correspond to a gas outlet port according to an aspect of the embodiments.

Further, the outlet part 35C is provided with an oil discharge port 15C for discharging oil separated from the coolant gas. An oil return pipe 15F is connected to the oil discharge port 15C. The oil return pipe 15F is connected to the oil return pipe 24 illustrated in FIG. 1.

The filter element 36 includes a first filter member 37, a second filter member 38, and an oil separating member 39.

The first filter member 37, the second filter member 38, and the oil separating member 39 may correspond to a first filtration part, a second filtration part, and an oil separating part, respectively, according to an aspect of the present invention.

The first filter member 37 is provided by placing a filter material inside the cylindrical part 35A. The first filter member 37 is configured to filter out oil from the coolant gas. Further, the second filter member 38 is provided on the downstream side of the first filter member 37 inside the cylindrical part 35A by placing a filter material so that there is a gap between the first filter member 37 and the second filter member 38. The second filter member 38 is configured to filter out oil from the coolant gas.

It is preferable that the first filter member 37 be made of a filter material having a fiber structure in order to separate oil. Examples of the material of the first filter member 37 include glass wool.

It is preferable that the second filter member 38 also be made of a filter material having a fiber structure in order to separate oil. Examples of the material of the second filter member 38 include glass wool.

The first filter member 37 and the second filter member 38 may be the same member. In this case, an air gap is provided at a point along a coolant gas passage in the filter member formed of the same member as a whole, and the oil separating member 39 is placed in the air gap. That is, the filter element 36 has a layered structure of multiple filter members stacked in layers with an oil separating member interposed between adjacent filter members.

The oil separating member 39 includes a first perforated plate 39A provided on the downstream-side end face of the first filter member 37. The oil separating member 39 is configured to separate oil from the coolant gas by having oil filtered out with the first filter member 37 run down the surface of the first perforated plate 39A. The oil separating member 39 is configured to fix and support the first filter member 37 with the first perforated plate 39A.

As the first perforated plate 39A, for example, a punching plate may be used that has through holes of approximately 6 mm in inside diameter formed in a staggered arrangement in, for example, a metal plate with the through holes arranged at intervals of approximately 15 mm in a first direction and at intervals of approximately 10 mm in a second direction perpendicular to the first direction, for example.

The oil separating member 39 may include a second perforated plate 39B provided on the upstream-side end face of the second filter member 38. The oil separating member 39 may be configured to fix and support the second filter member 38 with the second perforated plate 39B.

Like the first perforated plate 39A, the second perforated plate 39B may employ, for example, a punching plate that has through holes of approximately 6 mm in inside diameter formed in a staggered arrangement in, for example, a metal plate with the through holes arranged at intervals of approximately 15 mm in a first direction and at intervals of approximately 10 mm in a second direction perpendicular to the first direction, for example.

The second perforated plate 39B may be fixed to the first perforated plate 39A via a spacer member 39C. This allows the first perforated plate 39A and the second perforated plate 39B to be spaced apart from each other with the air gap between the first perforated plate 39A and the second perforated plate 39B being kept constant. Therefore, it is possible to keep the size of the air gap between the first filter member 37 and the second filter member 38 (the size of the air gap between the first perforated plate 39A and the second perforated plate 39B) at a fixed value.

A perforated plate 37A having the same configuration as the first perforated plate 39A may be provided on the upstream-side end face of the first filter member 37. This allows the first filter member 37 to be fixed and supported from both the upstream side and the downstream side.

Further, a perforated plate 38A having the same configuration as the second perforated plate 39B may also be provided on the downstream-side end face of the second filter member 38. This allows the second filter member 38 to be fixed and supported from both the upstream side and the downstream side.

According to this embodiment, the oil separator 15, which is a horizontal oil separator, may be provided on the placement table 35D at such an angle as to have the bottom of the outlet part 35C positioned lower than the bottom of the inlet part 35B. This makes it possible to cause oil deposited at the bottom of the cylindrical part 35A to flow from the upstream side to the downstream side with ease. However, the oil separator 15 may also be so provided on the placement table 35D as to have the cylindrical part 35A extending substantially horizontally so that the bottom of the outlet part 35C and the bottom of the inlet part 35B are substantially level with each other as illustrated in FIG. 3.

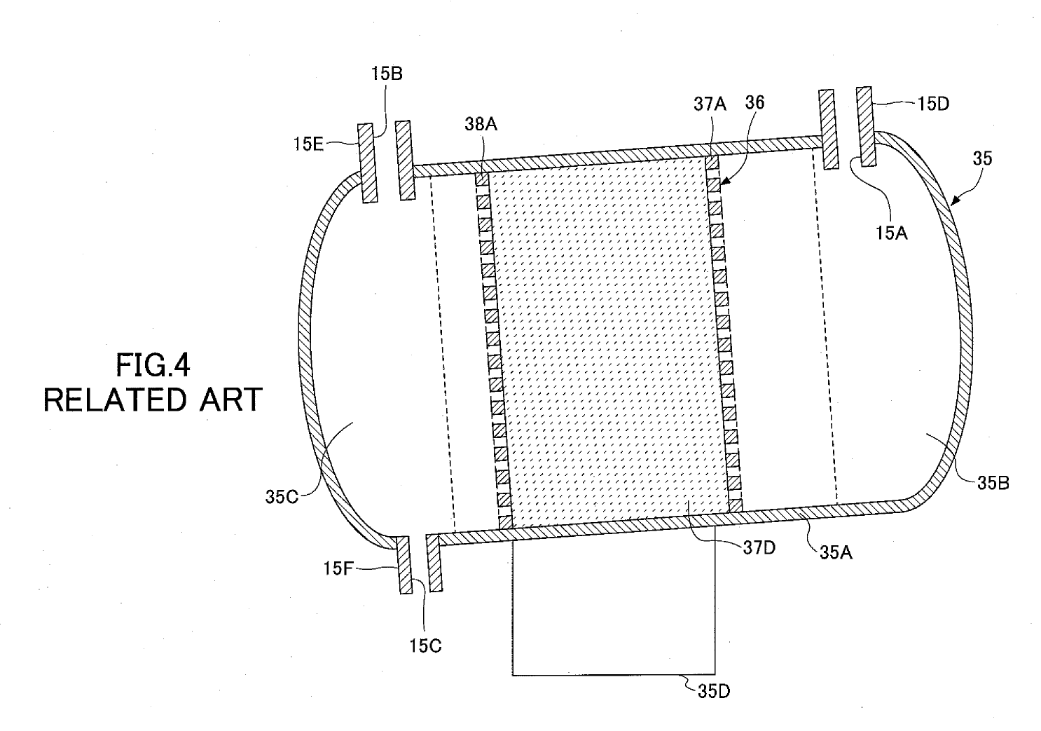

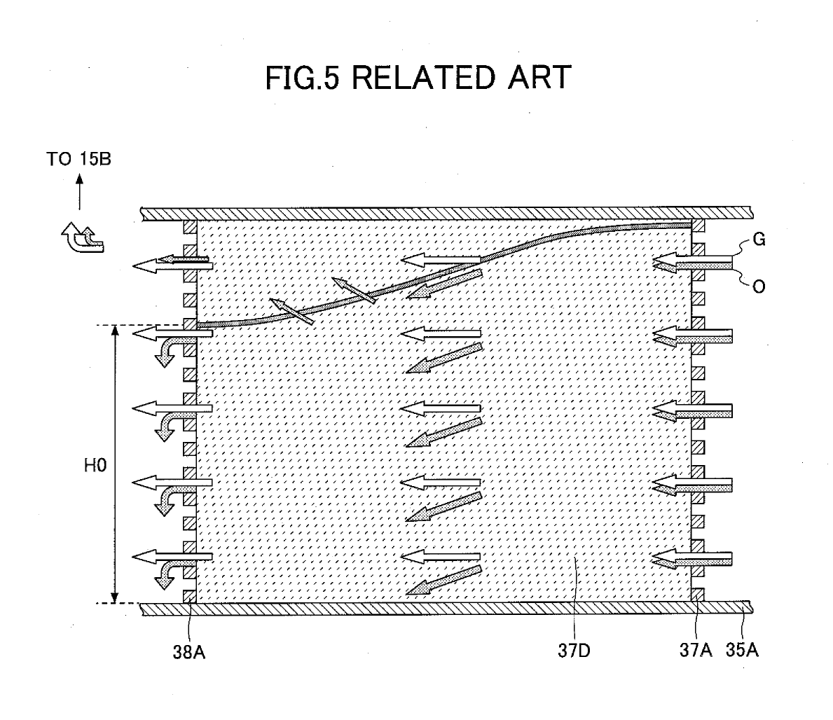

Here, a description is given, in comparison with a comparative example with reference to FIG. 4 through FIG. 6, of the effect that it is possible for the oil separator 15 according to this embodiment to prevent the ejection of oil from the entire downstream-side end face of a filter member that filters out oil.

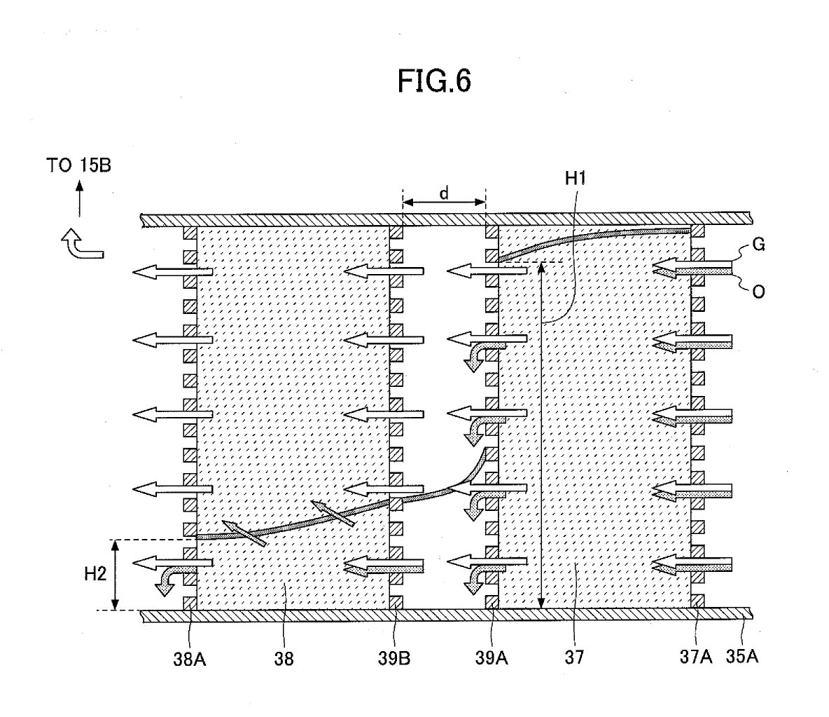

FIG. 4 is a cross-sectional view of an oil separator according to a comparative example. FIG. 5 is a schematic diagram illustrating how coolant gas containing oil passes through a filter member 37D of the oil separator according to the comparative example. FIG. 6 is a schematic diagram illustrating how coolant gas containing oil passes through the first and second filter members 37 and 38 of the oil separator 15 according to this embodiment.

FIG. 4 and FIG. 5 illustrate a case where the perforated plates 37A and 38A are provided on the upstream-side end face and the downstream-side end face, respectively, of the filter member 37D. Further, FIG. 6 illustrates a case where the first perforated plate 39A is provided on the downstream-side end face of the first filter member 37, the second perforated plate 39B is provided on the upstream-side end face of the second filter member 38, and the perforated plates 37A and 38A are provided on the upstream-side end face of the first filter member 37 and the downstream-side end face of the second filter member 38, respectively. Further, in FIG. 5 and FIG. 6, for facilitating graphical representation, the oil separator 15 is described as extending horizontally without a tilt. Further, in FIG. 6, the graphical representation of the spacer member 39C is omitted. Furthermore, in FIG. 5 and FIG. 6, a flow of coolant gas is indicated by arrows G and a flow of oil is indicated by arrows O.

Like the oil separator 15 according to the first embodiment, the oil separator according to the comparative example also includes the shell 35 and the filter element 36. However, in the oil separator according to the comparative example, the filter element 36 is formed of the filter member 37D, and neither an air gap nor an oil separating member is provided in the filter member 37D.

In FIG. 4 and FIG. 5, the same elements as those of the oil separator 15 according to the first embodiment are referred to by the same reference numerals, and a description thereof is omitted.

When coolant gas containing oil passes through the filter member 37D of the oil separator according to the comparative example, oil is likely to penetrate in every direction around through capillary action or oil is less likely to flow downward in the filter member 37D because of an increase in the oil retaining capability of the filter member 37D. As a result, as illustrated in FIG. 5, oil is ejected from an upper part, that is, a part near the high-pressure gas outlet port 15B, of the downstream-side end face of the filter member 37D to flow out of the high-pressure gas outlet port 15B in droplets or a mist, being accompanied by the coolant gas.

Further, as illustrated in FIG. 5, the height of the oil liquid level at the downstream-side end face of the filter member 37D is H0.

On the other hand, in the oil separator 15 according to this embodiment, an air gap is interposed between the first filter member 37 and the second filter member 38 as illustrated in FIG. 6. This allows oil to gradually move downward in the first filter member 37 and the second filter member 38 because of its own weight when coolant gas containing oil passes through the first filter member 37 and the second filter member 38, so that oil is likely to be separated from the coolant gas. Further, oil filtered out with the first filter member 37 runs down the surface of the first perforated plate 39A, so that oil is likely to be separated from the coolant gas. As a result, it is possible to prevent oil from being ejected from an upper part, that is, a part near the high-pressure gas outlet port 15B, of the downstream-side end face of the second filter member 38. Further, oil is ejected in concentration from a lower part of the downstream-side end face of the second filter member 38, and the density of oil is extremely greater than the density of coolant gas. Therefore, oil is in the form of droplets or a mist and is less likely to be accompanied by the coolant gas.

As illustrated in FIG. 6, letting the height of the oil liquid level at the downstream-side end face of the first filter member 37 and the height of the oil liquid level at the downstream-side end face of the second filter member 38 be H1 and H2, respectively, it is possible to make H2 less than H1 (H2<H1) and to make H2 less than H0 (H2<H0).

Therefore, according to this embodiment, it is possible to prevent oil from being ejected from the entire downstream-side end face of a filter member that filters out oil.

According to this embodiment, letting the velocity of coolant gas passing through the filter member 37 be v, letting a predetermined coefficient be k, and letting the distance (the size of the air gap) between the first filter member 37 and the second filter member 38 be d, it is preferable that v, k, and d satisfy the following:

d≧kv. (1)

That is, the size of the air gap between the first filter member 37 and the second filter member 38, d, is preferably greater than or equal to a value obtained by multiplying the velocity of coolant gas passing through the first filter member 37, v, by the predetermined coefficient k.

When the oil separating member 39 includes the first perforated plate 39A and the second perforated plate 39B, the size of the air gap between the first filter member 37 and the second filter member 38, d, means the size of the air gap between the first perforated plate 39A and the second perforated plate 39B.

Letting the flow rate of coolant gas passing through the first filter member 37 be Q, letting the cross-sectional area of the first filter member 37 be S, letting the substance density of the filter material of the first filter member 37 be ρ₀, and letting the filling density (actual density) of the filter material of the first filter member 37 be ρ, the velocity of coolant gas passing through the first filter member 37, v, is expressed by:

$$v = \frac{Q}{S} / \frac{{ρ}_{0} - ρ}{{ρ}_{0}} . \qquad ( 2 )$$

Accordingly, from Eqs. (1) and (2), it is preferable that the size of the air gap between the first filter member 37 and the second filter member 38, d, satisfy:

$$d \geq k \frac{Q}{S} / \frac{{ρ}_{0} - ρ}{{ρ}_{0}} . \qquad ( 3 )$$

That is, the size of the air gap between the first filter member 37 and the second filter member 38, d, is preferably greater than or equal to a value obtained by multiplying, by the predetermined coefficient k, a value obtained by dividing the flow rate of coolant gas passing through the first filter member 37, Q, by the product of the cross-sectional area of the first filter member 37, S, and the sparseness of the first filter member 37, (ρ₀−ρ)/ρ₀.

Here, an examination is made of the relationship between the air gap size d and the outlet velocity of oil, vo, which is the outflow (amount) of oil that flows out from the high-pressure gas outlet port 15B per unit time, in Example 1 of Table 1 below.

TABLE 1

| | Example 1 | Example 2 |
|---|---|---|
| Cross-sectional area S (m²) | 0.018 | 0.058 |
| Flow rate Q (Nm³/H) | 110 | 110 |
| Filter material substance | 2500 | 2500 |
| density ρ₀ (kg/m³) | | |
| Filter material filling | 400 | 48 |
| density ρ (kg/m³) | | |
| Sparseness (ρ₀ − ρ)/ρ₀ | 0.84 | 0.98 |
| Coefficient k | 1.4 × 10⁻⁶ | 1.4 × 10⁻⁶ |
| Air gap size d optimum | 10 | 2.7 |
| value (minimum value) (mm) | | |

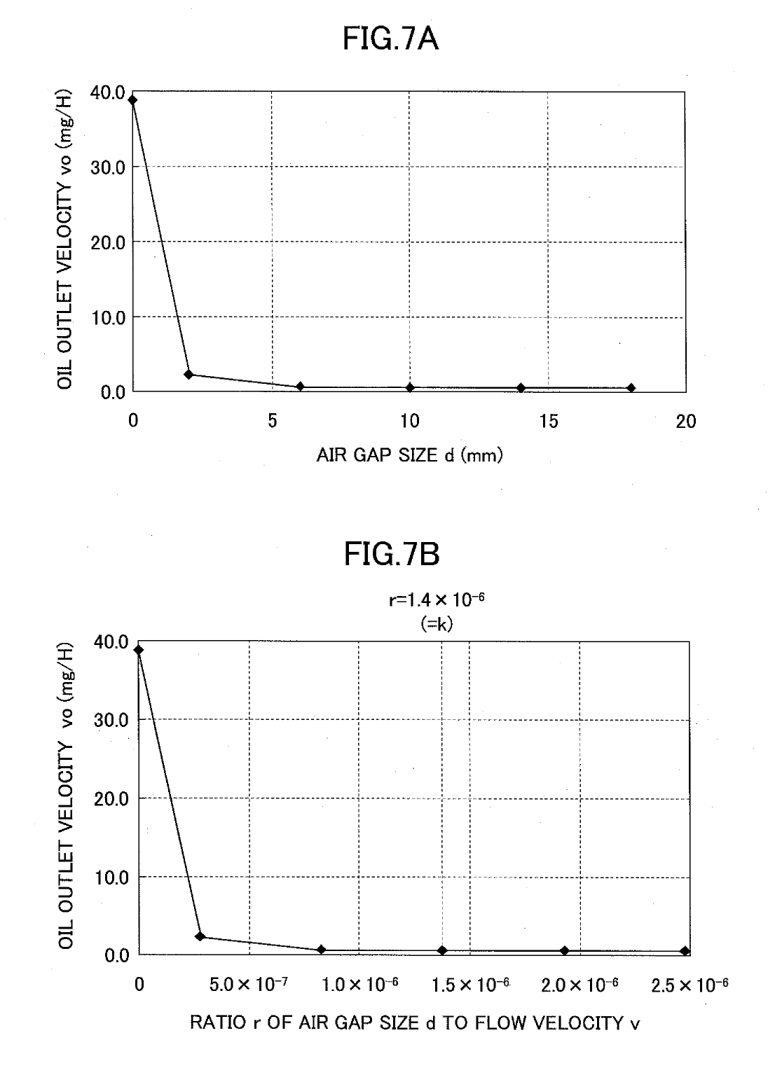

Here, the outflow (amount) of oil may be measured by, for example, providing a filter or a trap in the high-pressure gas lead-out pipe 15E and measuring the amount of oil flowing through the high-pressure gas lead-out pipe 15E. FIG. 7A illustrates the relationship between the air gap size d and the oil outlet velocity vo at this time.

It has been found that as illustrated in FIG. 7A, the oil outlet velocity vo sharply decreases as the air gap size d increases from 0 mm to 2 mm, and remains converged on a substantially fixed value in a range where the air gap size d is greater than or equal to 10 mm as the air gap size d further increases to 6 mm, 10 mm, 14 mm, and 18 mm.

FIG. 7B illustrates a graph where a variable r, which is the ratio of the air gap size d to the (flow) velocity of coolant gas, v, that is, the variable r expressed by the following equation:

r=d/v, (4)

replaces the air gap size d of the graph of FIG. 7A as the axis of abscissa. It has been found that as illustrated in FIG. 7B, the oil outlet velocity vo decreases as the variable r increases from 0 to 1.4×10⁻⁶, and remains converged on a substantially fixed value as the variable r further increases to values greater than or equal to 1.4×10⁻⁶.

Accordingly, as illustrated in FIG. 7B, it is possible to sufficiently reduce the oil outlet velocity vo when the variable r, which is the ratio of the air gap size d to the (flow) velocity of coolant gas, v, is greater than or equal to the predetermined value k (k=1.4×10⁻⁶). As a result, it is possible to separate filtered-out oil from the coolant gas with efficiency.

That is, the predetermined coefficient k is a value equal to the ratio r of the air gap size d to the (flow) velocity of coolant gas, v, at the time when the oil outlet velocity vo decreases to converge on a substantially fixed value in the case of increasing the air gap size d. The air gap size d at this point is the optimum value (minimum value) of the air gap size.

In Example 1 of Table 1, the value of the air gap size d at the time of k=1.4×10⁻⁶ is 10 mm. Therefore, the air gap size d is preferably greater than or equal to 10 mm.

The above-described relationship between the air gap size d and the oil outlet velocity vo holds substantially the same in the case of changing the parameters described in Example 1 of Table 1 as well.

Examples of the specifications of actually used oil separators include those greater in the cross-sectional area S and the sparseness (ρ₀−ρ)/ρ₀, that is, in the ratio r of the air gap size d to the (flow) velocity of coolant gas, v, than Example 1 of Table 1. Table 1 illustrates one of such examples as Example 2.

In Example 2 of Table 1 as well, in the case of increasing the air gap size d (increasing the variable r), the oil outlet velocity vo substantially converges when the variable r becomes k=1.4×10⁻⁶. Further, the value of the air gap size d at the time of k=1.4×10⁻⁶ is 2.7 mm. Accordingly, in Example 2 of Table 1, the air gap size d is preferably greater than or equal to 2.7 mm.

This makes it possible to prevent oil from being ejected from the entire downstream-side end face of a filtration part that filters out oil and to separate the filtered-out oil from coolant gas with efficiency.

### First Variation of First Embodiment

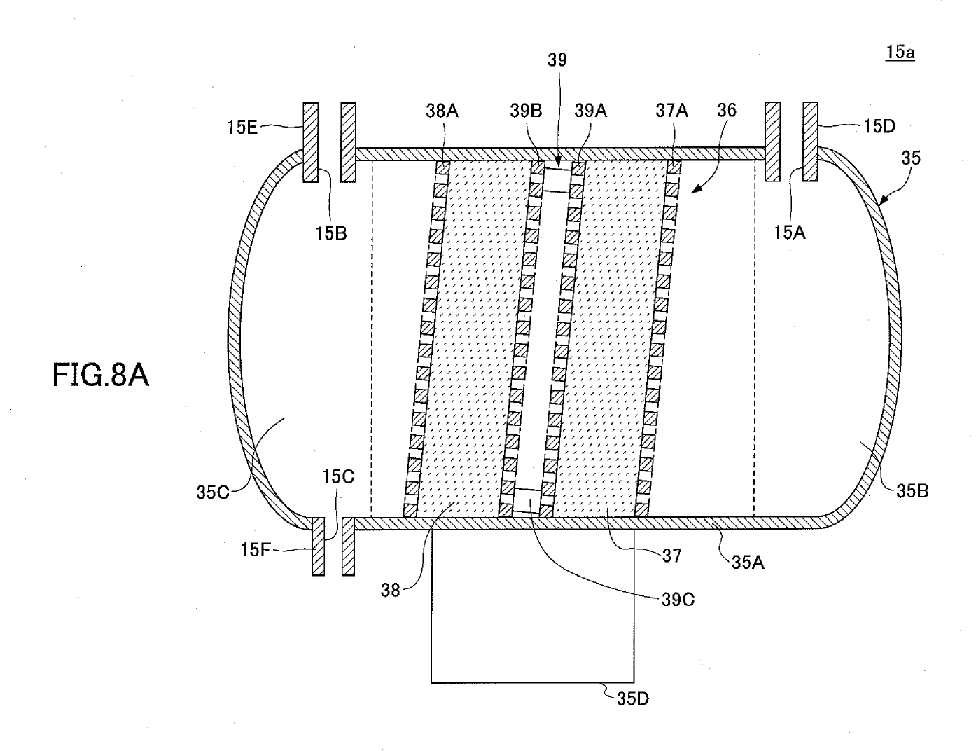

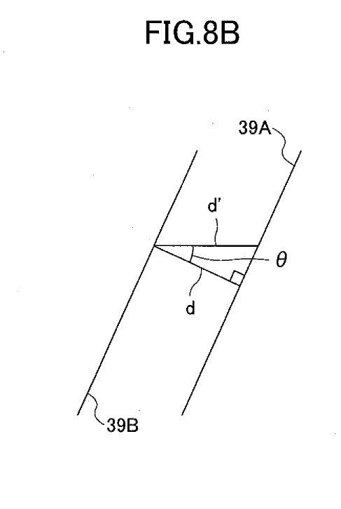

Next, a description is given, with reference to FIGS. 8A and 8B, of an oil separator according to a first variation of the first embodiment. In an oil separator 15a according to this variation, the air gap between the first filter member 37 and the second filter member 38 is provided not perpendicular to the axial directions of the cylindrical part 35A but with an inclination to the upstream side (for example, relative to a direction perpendicular to the axial directions of the cylindrical part 35A).

FIG. 8A is a cross-sectional view of the oil separator 15a according to this variation, illustrating a configuration of the oil separator 15a. FIG. 8B is a diagram for illustrating an angle of inclination θ.

The oil separator 15a according to this variation also has the same configuration as the oil separator 15 according to the first embodiment except for the filter element 36. Accordingly, in FIGS. 8A and 8B, the same elements as those of the oil separator 15 according to the first embodiment are referred to by the same reference numerals as those of the oil separator 15, and a description of other parts than the filter element 36, including a description of the compressor 10, is omitted in this variation.

This variation is the same as the first embodiment in that the oil separator 15a includes the shell 35 and the filter element 36 and that the shell 35 includes the cylindrical part 35A, the inlet part 35B, the outlet part 35C, and the placement table 35D.

The filter element 36 includes the first filter member 37, the second filter member 38, and the oil separating member 39.

Like in the first embodiment, the first filter member 37 is provided inside the cylindrical part 35A. Further, like in the first embodiment, the second filter member 38 is provided on the downstream side of the first filter member 37 inside the cylindrical part 35A with a gap between the first filter member 37 and the second filter member 38.

In the oil separator 15a according to this variation, however, the air gap between the first filter member 37 and the second filter member 38 is provided not perpendicular to the axial directions of the cylindrical part 35A but with an inclination to the upstream side. Accordingly, the first filter member 37 and the second filter member 38 are so provided as to be positioned with an inclination to the upstream side and substantially parallel to each other.

The first filter member 37 and the second filter member 38 may be formed of the same material as in the first embodiment.

The oil separating member 39 includes the first perforated plate 39A provided on the downstream-side end face of the first filter member 37. Since the first filter member 37 is so provided as to tilt to the upstream side, the first perforated plate 39A also is so provided as to tilt to the upstream side.

The oil separating member 39 may include the second perforated plate 39B provided on the upstream-side end face of the second filter member 38. If the second filter member 38 is so provided as to tilt to the upstream side, the second perforated plate 39B may also be so provided as to tilt to the upstream side.

Further, the second perforated plate 39B may be fixed to the first perforated plate 39A via the spacer member 39C. The perforated plate 37A having the same configuration as the first perforated plate 39A or the like may also be provided on the upstream-side end face of the first filter member 37. The perforated plate 38A having the same configuration as the first perforated plate 39A or the like may also be provided on the downstream-side end face of the second filter member 38.

According to this variation as well, oil is allowed to gradually move downward in the first filter member 37 and the second filter member 38 because of its own weight, so that oil is likely to be separated from the coolant gas.

In addition to this, according to this variation, the first filter member 37 and the second filter member 38 are inclined to the upstream side. This allows an increase in the size of the air gap between the downstream-side end face of the first filter member 37 and the upstream-side end face of the second filter member 38 along (the length of) the cylindrical part 35A (coolant gas passage), d′.

Letting an angle of inclination be θ, the air gap size d′ is expressed by:

d′=d/cos θ>d, (5)

as illustrated in FIG. 8B. Accordingly, it is possible to increase the air gap size d′ by increasing the angle of inclination θ. As explained using FIG. 7A and FIG. 7B, an increase in the air gap size reduces the oil outlet velocity vo. Accordingly, an increase in air gap size d′ makes it easier for oil to move downward in the first filter member 37 and the second filter member 38, so that oil is more likely to be separated from the coolant gas.

Further, in this variation, the oil separator 15a, which is a horizontal oil separator, may be so provided on the placement table 35D as to tilt downward from the upstream side to the downstream side so that the bottom of the outlet part 35C is positioned lower than the bottom of the inlet part 35B. Letting the angle of inclination of the oil separator 15a be θ₀, the air gap size d′ is expressed by:

d′=d/cos(θ−θ₀). (6)

Therefore, θ is preferably greater than θ₀ (θ>θ₀).

In this variation as well, when the oil separating member 39 includes the first perforated plate 39A and the second perforated plate 39B, the size of the air gap between the first filter member 37 and the second filter member 38, d′, means the size of the air gap between the first perforated plate 39A and the second perforated plate 39B.

### Second Variation of First Embodiment

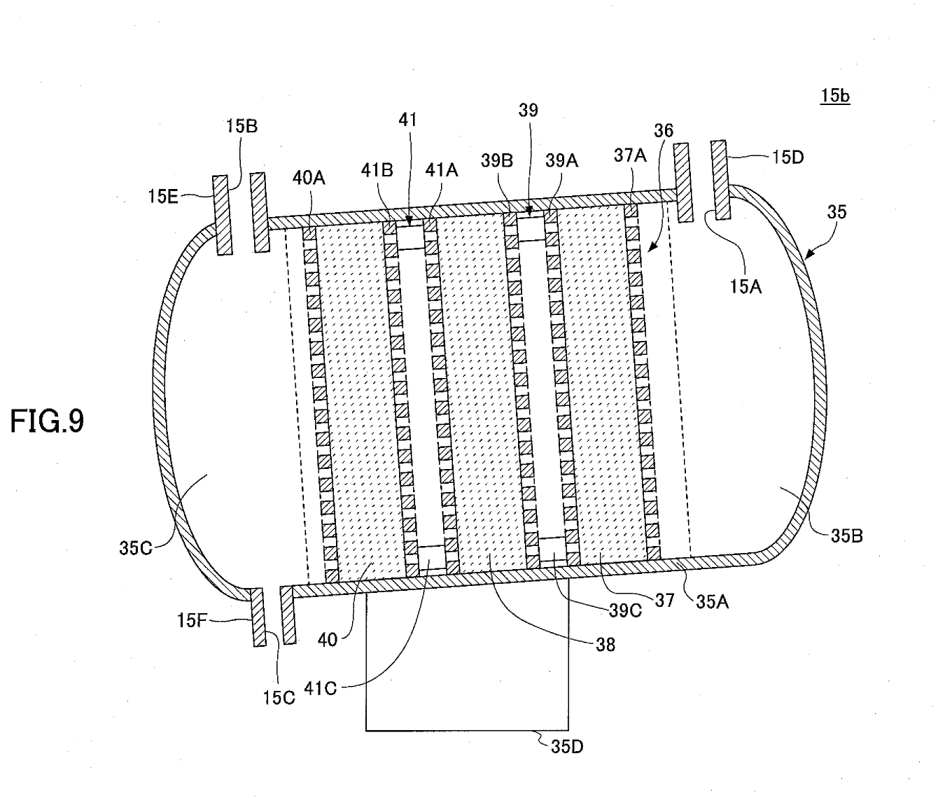

Next, a description is given, with reference to FIG. 9, of an oil separator according a second variation of the first embodiment. In an oil separator 15b according to this variation, filter members are provided to be stacked in three layers in the axial directions of the cylindrical part 35A, and an air gap is provided between adjacent filter members.

FIG. 9 is a cross-sectional view of the oil separator 15b according to this variation, illustrating a configuration of the oil separator 15b.

The oil separator 15b according to this variation also has the same configuration as the oil separator 15 according to the first embodiment except for the filter element 36. Accordingly, in FIG. 9, the same elements as those of the oil separator 15 according to the first embodiment are referred to by the same reference numerals as those of the oil separator 15, and a description of other parts than the filter element 36, including a description of the compressor 10, is omitted in this variation.

This variation is the same as the first embodiment in that the oil separator 15b includes the shell 35 and the filter element 36 and that the shell 35 includes the cylindrical part 35A, the inlet part 35B, the outlet part 35C, and the placement table 35D.

Further, like in the first embodiment, the filter element 36 includes the first filter member 37, the second filter member 38, and the oil separating member 39.

On the other hand, according to this variation, the filter element 36 includes a third filter member 40 and a second oil separating member 41 in addition to the first filter member 37, the second filter member 38, and the oil separating member 39.

The third filter member 40 is provided on the downstream side of the second filter member 38 inside the cylindrical part 35A with a gap between the second filter member 38 and the third filter member 40. The third filter member 40 is configured to filter out oil from coolant gas.

It is preferable that the third filter member 40 also be made of a filter material having a fiber structure in order to separate oil. Examples of the material of the third filter member 40 include glass wool.

The first filter member 37, the second filter member 38, and the third filter member 40 may be the same member. In this case, air gaps are provided at two points along the coolant gas passage in the filter member formed of the same member as a whole, and oil separating members are provided in the respective air gaps. That is, the filter element 36 has a layered structure of multiple filter members stacked in layers by interposing oil separating members between respective adjacent filter members (alternate layers of multiple filter members and multiple oil separating members).

The second oil separating member 41 includes a third perforated plate 41A provided on the downstream-side end face of the second filter member 38. The second oil separating member 41 is configured to separate oil from the coolant gas by having oil filtered out with the second filter member 38 run down the surface of the third perforated plate 41A. The second oil separating member 41 is configured to fix and support the second filter member 38 with the third perforated plate 41A. In addition, the third perforated plate 41A may be the same in material and the like as the first perforated plate 39A of the oil separating member 39.

Further, the second oil separating member 41 may include a fourth perforated plate 41B provided on the upstream-side end face of the third filter member 40. The second oil separating member 41 may be configured to fix and support the third filter member 40 with the fourth perforated plate 41B.

Further, the fourth perforated plate 41B may be fixed to the third perforated plate 41A via a spacer member 41C. The perforated plate 37A having the same configuration as the first perforated plate 39A or the like may be provided on the upstream-side end face of the first filter member 37. Further, a perforated plate 40A having the same configuration as the first perforated plate 39A or the like may also be provided on the downstream-side end face of the fourth filter member 40.

According to this variation, oil is allowed to gradually move downward in the first filter member 37, the second filter member 38, and the third filter member 40 because of its own weight, so that oil is more likely to be separated from the coolant gas.

### Second Embodiment

Next, a description is given, with reference to

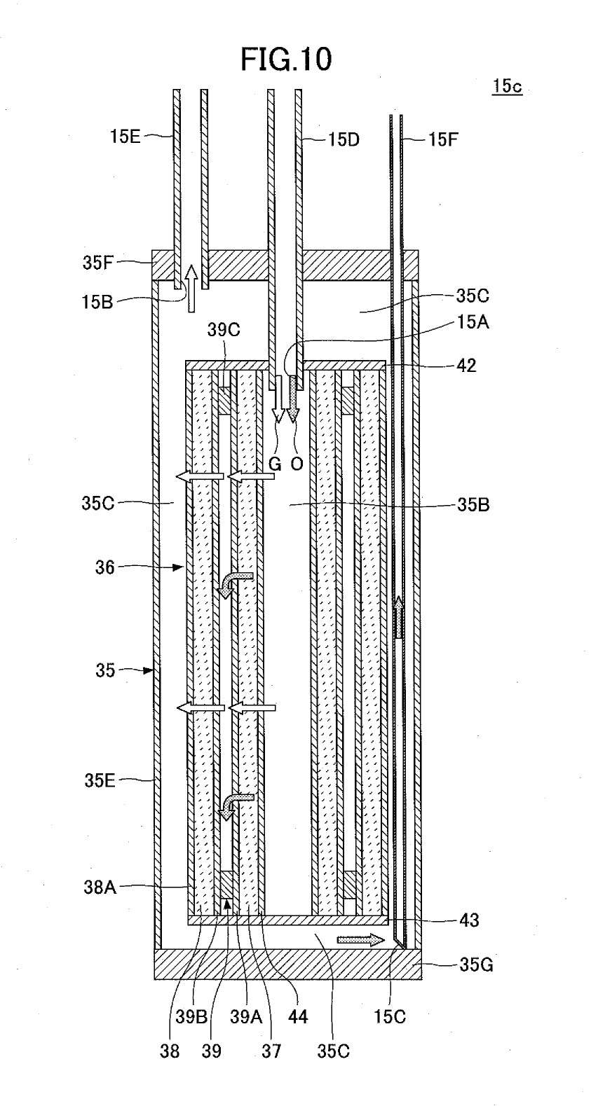

FIG. 10, of an oil separator according to a second embodiment. An oil separator 15c according to this embodiment is an application of an oil separator according to the present invention to a vertical oil separator.

The oil separator 15c according to this embodiment has the first filter member 37 and the second filter member 38, each having a cylindrical shape, provided concentrically with each other in a cylindrical part 35E elongated (extending) substantially vertically. Further, an air gap is provided between the concentrically provided first and second filter members 37 and 38.

The oil separator 15c according to this embodiment also has the same configuration as the oil separator 15 according to the first embodiment except for the filter element 36. Accordingly, a description of other parts than the filter element 36, including a description of the compressor 10, is omitted in this variation.

FIG. 10 is a cross-sectional view of the oil separator 15c according to this embodiment, illustrating a configuration of the oil separator 15c.

In FIG. 10, a flow of coolant gas is indicated by arrows G, and a flow of oil is indicated by arrows O.

The oil separator 15c includes the shell 35 and the filter element 36.

The shell 35 includes the cylindrical part 35E, an upper flange 35F, and a lower flange 35G. The cylindrical part 35E has a hollow, cylindrical shape. In this embodiment, however, the axis of the cylindrical part 35E extends substantially vertically. The lower flange 35G is so fixed to the lower end portion of the cylindrical part 35E by welding as to hermetically close (seal) the lower end portion of the cylindrical part 35E. The upper flange 35F is so fixed to the upper end portion of the cylindrical part 35E by welding as to hermetically close (seal) the upper end portion of the cylindrical part 35E.

The upper flange 35F is provided with the high-pressure gas introduction pipe 15D, the high-pressure gas outlet port 15B, and the oil return pipe 15F.

The high-pressure gas introduction pipe 15D is provided through the upper flange 35F. The high-pressure gas introduction pipe 15D is connected to the high-pressure-side pipe 13A illustrated in FIG. 1 above the upper flange 35F. Further, as described below, the high-pressure gas introduction pipe 15D is connected to the high-pressure gas inlet port 15A provided in an upper lid body 42 below the upper flange 35F.

The high-pressure gas inlet port 15A may correspond to a gas inlet port according to an aspect of the present invention. The high-pressure gas outlet port 15B may correspond to a gas outlet port according to an aspect of the present invention.

The high-pressure gas lead-out pipe 15E is connected to the high-pressure gas outlet port 15B. The high-pressure gas lead-out pipe 15E is connected to the high-pressure-side pipe 13B illustrated in FIG. 1.

The oil return pipe 15F extends from the upper flange 35F to the vicinity of the lower flange 35G. The oil discharge port 15C for discharging oil separated from the coolant gas is provided at the lower end portion of the oil return pipe 15F. The oil return pipe 15F is connected to the oil return pipe 24 illustrated in FIG. 1 above the upper flange 35F.

The filter element 36 includes the first filter member 37, the second filter member 38, the oil separating member 39, the upper lid body 42, and a lower lid body 43. The first filter member 37, the second filter member 38, and the oil separating member 39 may correspond to a first filtration part, a second filtration part, and an oil separating part, respectively, according to an aspect of the present invention.

The upper lid body 42 is provided with the high-pressure gas inlet port 15A. The high-pressure gas introduction pipe 15D is connected to the high-pressure gas inlet port 15A.

A core member 44, which is formed by, for example, bending a punching plate into a cylindrical shape, is provided between the upper lid body 42 and the lower lid body 43. The space inside the core member 44 between (defined by) the upper lid body 42 and the lower lid body 43, where the high-pressure gas inlet port 15A is provided, corresponds to the inlet part 35B.

Further, the space over the upper lid body 42 between (defined by) the upper flange 35F and the upper lid body 42, where the high-pressure gas outlet port 15B is provided, corresponds to the outlet part 35C. Further, the space laterally around the filter element 36 may also correspond to the outlet part 35C. Further, the space under the lower lid body 43 between (defined by) the lower flange 35G and the lower lid body 43, where the oil discharge port 15C is provided, may also correspond to the outlet part 35C.

The first filter member 37 is provided by placing (winding) a filter material cylindrically around the cylindrical core member 44. Further, the second filter member 38 is provided by placing (winding) a filter material cylindrically around the cylindrically wound first filter member 37. The second filter member 38 is provided substantially concentrically with the first filter member 37. Like the core member 44, the first filter member 37 and the second filter member 38 are so provided as to be between (defined by) the upper lid body 42 and the lower lid body 43.

According to this embodiment, coolant gas flows outward from the core member 44 in the radial directions of the first filter member 37 and the second filter member 38. That is, coolant gas flows radially when viewed in a direction from above the filter element 36. Accordingly, the first filter member 37 is provided by placing a filter material at a point along the coolant gas passage to filter out oil from the coolant gas. Further, the second filter member 38 is provided by placing a filter material on the downstream side of the first filter member 37 at a point along the coolant gas passage so that there is a gap between the first filter member 37 and the second filter member 38. The second filter member 38 is configured to filter out oil from the coolant gas.

In this embodiment as well, it is preferable that the first filter member 37 and the second filter member 38 be made of a filter material having a fiber structure in order to separate oil. Examples of the material of the first filter member 37 and the second filter member 38 include glass wool.

The first filter member 37 and the second filter member 38 may be the same member. In this case, an air gap is provided at a point along the radial directions of the cylindrical filter member formed of the same member as a whole, and the oil separating member 39 is provided in the air gap.

The oil separating member 39 includes the first perforated plate 39A provided on the exterior circumferential surface (peripheral surface) of the first filter member 37, which is the downstream-side end face of the first filter member 37. The oil separating member 39 is configured to separate oil from the coolant gas by having oil filtered out with the first filter member 37 run down the surface of the first perforated plate 39A. The oil separating member 39 is configured to fix and support the first filter member 37 with the first perforated plate 39A.

The oil separating member 39 may include the second perforated plate 39B provided on the interior circumferential surface of the second filter member 38, which is the upstream-side end face of the second filter member 38. The oil separating member 39 may be configured to fix and support the second filter member 38 with the second perforated plate 39B.

Further, the second perforated plate 39B may be fixed to the first perforated plate 39A via the spacer member 39C. This allows the first perforated plate 39A and the second perforated plate 39B to be held with a constant interval (distance) between the exterior circumferential surface or the downstream-side end face of the first perforated plate 39A and the interior circumferential surface or the upstream-side end face of the second perforated plate 39B. Therefore, it is possible to keep the size of the air gap between the exterior circumferential surface (peripheral surface) of the first filter member 37 and the interior circumferential surface of the second filter member 38 at a fixed value.

Further, the perforated plate 38A having the same configuration as the second perforated plate 39B may be provided on the exterior circumferential surface (peripheral surface) or the downstream-side end face of the second filter member 38. This allows the second filter member 38 to be fixed and supported from both the upstream side and the downstream side.

According to this embodiment as well, oil is allowed to gradually move downward in the first filter member 37 and the second filter member 38 because of its own weight, so that oil is likely to be separated from the coolant gas.

According to an aspect of the present invention, in an oil separator configured to separate oil from coolant gas ejected from a compressor for a refrigerator, it is possible to prevent oil from being ejected from the entire downstream-side end face of a filtering part configured to filter out oil and to separate the filtered-out oil from the coolant gas with efficiency.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present inventions have been described in detail, it should be understood that various changes, substitutions, and alterations could be made hereto without departing from the spirit and scope of the invention.

For example, in the above description of the embodiments, the configuration using punching metal as a perforated plate is taken as an example. However, embodiments of the present invention are not limited to using a perforated member such as punching metal as a perforated plate, and any configurations such as those using wire mesh, a plate provided with slits, a member formed of rods arranged in a lattice pattern, etc., may be employed as long as the configurations are capable of supporting a filter member and separating oil without blocking a flow of gas.

What is claimed is:

1. An oil separator configured to separate oil contained in coolant gas, comprising:
an inlet part provided on an upstream side in a passage through which the coolant gas flows from a compressor compressing the coolant gas toward a refrigerator generating cold by expanding the coolant gas, the inlet part including a gas inlet port configured to introduce the coolant gas;
an outlet part provided on a downstream side in the passage, the outlet part including a gas outlet port configured to lead out the coolant gas and an oil discharge port configured to discharge the separated oil;
a first filtration part provided between the inlet part and the outlet part and configured to filter out the oil from the coolant gas;
a second filtration part provided on a downstream side of the first filtration part with a gap between the first filtration part and the second filtration part, and configured to filter out the oil from the coolant gas; and
an oil separating part including a perforated plate provided on a downstream-side end face of the first filtration part.

2. The oil separator as claimed in claim 1, wherein the oil separating part further includes an additional perforated plate provided on an upstream-side end face of the second filtration part.

3. The oil separator as claimed in claim 2, further comprising:
a spacer member fixing the additional perforated plate to the perforated plate.

4. The oil separator as claimed in claim 1, further comprising:
a cylindrical part between the inlet part and the outlet part, the cylindrical part housing the first filtration part and the second filtration part,
wherein the downstream-side end face of the first filtration part is angled to an upstream side in the flow passage relative to a direction perpendicular to an axial direction of the cylindrical part.

5. The oil separator as claimed in claim 1, wherein the second filtration part is provided concentrically with the first filtration part.

6. An oil separator configured to separate oil contained in coolant gas, comprising:
an inlet port and an outlet port defining an upstream end and a downstream end, respectively, of a flow passage of the coolant gas in the oil separator;
a filter member provided in the flow passage and configured to filter out the oil from the coolant gas, the filter member including a first filtration part and a second filtration part spaced apart from each other, the second filtration part being on a downstream side of the first filtration part in the flow passage; and
an oil separating part including a perforated member provided on a downstream-side end face of the first filtration part.
